(19) United States
(12) Patent Application Publication
(10) Pub. No.: US 2019/0351460 A2
(43) Pub. Date: Nov. 21, 2019

(54) Apparatus And Method For Cleaning A Helical Member

(71) Applicants: David Fullarton,, Torquay, Devon (GB); Carl William Fullarton,, Torquay, Devon (GB)

(72) Inventor: William Fullarton, Kirkcudbright, Dumfries & Galloway (GB)

(21) Appl. No.: 15/781,633

(22) PCT Filed: Dec. 8, 2015
(86) PCT No.: PCT/GB2015/053748

§ 371 Date: Jun. 5, 2018

(51) Int. Cl. B08B 1/02; B08B 1/00; F28G 3/04; F28G 13/00; F28G 3/10; F28G 15/02

(52) U.S. Cl. CPC B08B 1/02; B08B 1/002; F28G 15/02; F28G 13/00; F28G 3/10; F28G 3/04

(57) ABSTRACT

This invention relates to an apparatus (10) for cleaning a helical member (52) such as a tabulator blade. The apparatus comprises opposed scrubbing brushes (32, 34) for removing deposits from the helical faces of the helical member (52) as it is passed between opposed bristles of the scrubbing brushes (32, 34). The opposed scrubbing brushes (32, 34) are mounted with the apparatus via a rotatable bearing (12) such that as the helical faces are reciprocated between the brushes, the continuously curving profile of the helical member (52) causes the brushes to rotate. Accordingly, the opposed scrubbing brushes (32, 34) maintain good contact with the helical surfaces thereby simplifying and improving the removal of deposits.

### CROSS-REFERENCE TO RELATED APPLICATIONS

This application is the United States National Phase of PCT Application No. PCT/GB2015/053748 filed 8 Dec. 2015 which is incorporated herein by reference.

### BACKGROUND OF THE INVENTION

The present invention relates to apparatus for cleaning a helical member, particularly, but not exclusively, a helical turbulator blade such as those found in heat exchangers.

In domestic and commercial boilers hot combustion gases typically pass into heat exchanger arrangements where the heat from said combustion gases is then transferred to e.g. heating circulation fluid and/or a hot water supply. Upon entering such heat exchangers the flow of combustion gases may be turbulent; however, there is often a tendency for this turbulent flow to migrate into a more laminar flow which can in turn reduce the efficiency of heat transfer within the heat exchanger.

For this reason, “turbulators” which are designed to deliberately create and/or maintain turbulence within the flow are commonly provided in heat exchangers in order to maintain or increase the turbulence of the gas flow there within and hence increase the overall efficiency of the heat exchanger. Such turbulator arrangements often comprise an array of several helical turbulator blades.

After prolonged use, the blades within such turbulator arrangements often become coated in carbon and other deposits imparted upon them by the passing combustion gases. The turbulator blades therefore require periodic cleaning in order to maintain the overall efficiency of the heat exchanger. Cleaning of the turbulator blades typically requires a maintenance engineer to gain access to the interior of the heat exchanger and then remove each of the turbulator blades in turn for subsequent cleaning. Any deposits are then manually brushed off each blade in turn with e.g. a wire brush.

The above maintenance operation is very time-consuming since the helical nature of each blade makes thorough cleaning of the blade relatively awkward; this is especially problematic in heat exchangers containing a large number of turbulator blades. Furthermore, when cleaning the turbulator blades in this way the removed deposits have a tendency to become airborne which, in turn, causes the removed deposits to be spread around the immediate vicinity. This also therefore tends to result in the maintenance engineer inhaling fine particles of removed deposit which can be harmful to the engineer's health (especially since an individual maintenance engineer may perform this same operation repeatedly over a short period for different customers). In addition to risking the maintenance engineer's health, the distributed particles of deposits tend to become deposited on surrounding objects which therefore requires a time-consuming clean-up operation to be undertaken after the maintenance has been completed.

According to a first aspect of the present invention there is provided apparatus for cleaning a helical member, the apparatus comprising at least a first scrubbing member having a working surface adapted to remove deposits from a first helical face of a helical member passed thereover and wherein the first scrubbing member is rotatably mounted on the apparatus such that, as the first helical face of the helical member is reciprocated over the first scrubbing member, the first helical face causes the first scrubbing member to rotate such that a working surface of the first scrubbing member remains substantially in contact with the first helical face to thereby remove deposits from the first helical face of the helical member

According to a second aspect of the present invention there is provided apparatus for cleaning a helical member, the apparatus comprising a first helical member retaining arrangement adapted to hold an end portion of a helical member, and a handle member, and wherein the retaining arrangement is rotatably mounted relative to the handle member such that when a user reciprocates the helical member past a scrubbing arrangement to remove debris from the helical member, the helical member is able to rotate relative to the handle member.

Further features and advantages of the first and second aspects of the present invention will become apparent from the appended claims and the following description.

Embodiments of the present invention will now be described by way of example only, with reference to the following diagrams, in which:

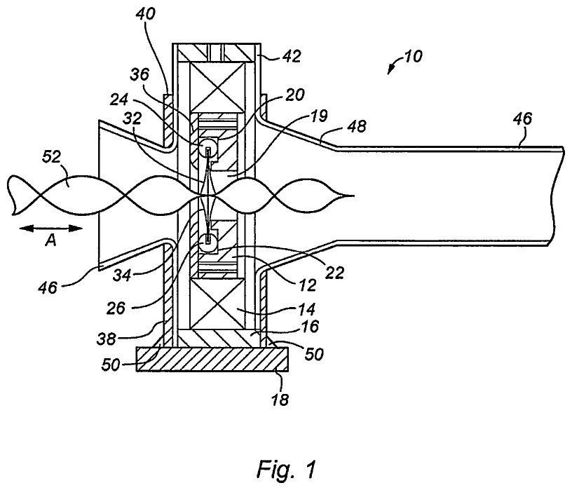

FIG. 1 is a schematic cross cross-sectional illustration of the apparatus according to a first aspect of the present invention where a helical member is illustrated in situ within the apparatus;

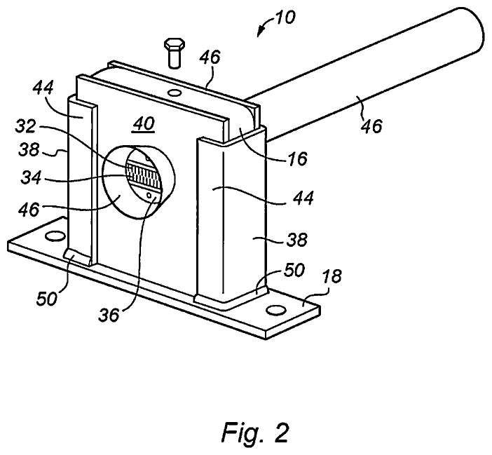

FIG. 2 is a schematic perspective illustration of the apparatus of FIG. 1 without the helical member present therein;

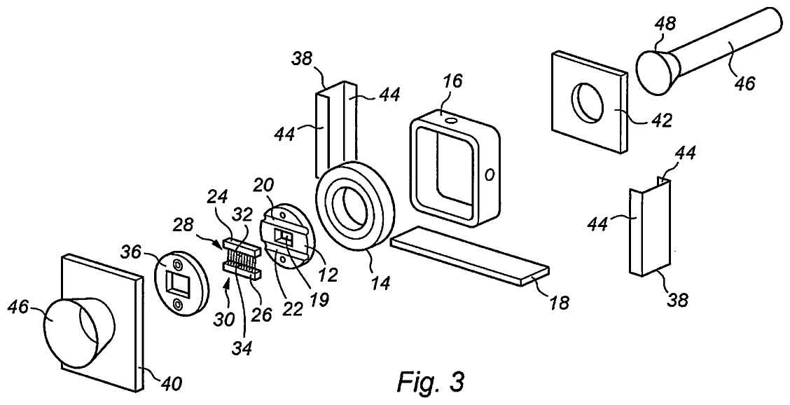

FIG. 3 is a schematic exploded perspective illustration of the apparatus of FIG. 2;

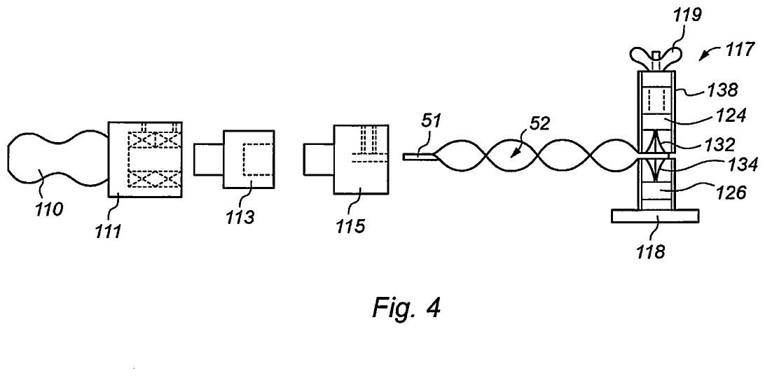

FIG. 4 is a schematic exploded transverse view of apparatus according to a second aspect of the present invention where the helical member rotates on a handle member and the brush members remain in a fixed position; and

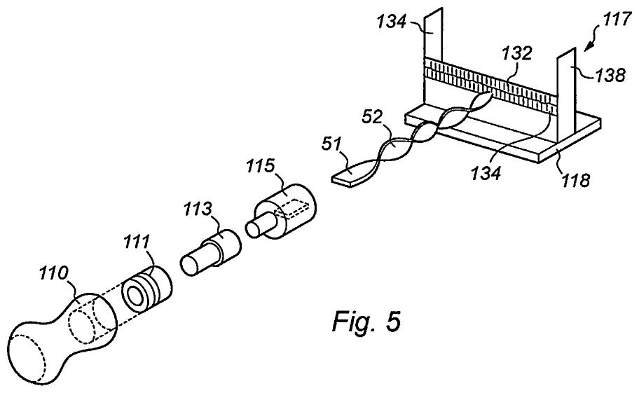

FIG. 5 is a schematic exploded perspective view of the apparatus shown in FIG. 4.

In the following description, the term helical is not to be construed as a helix in the strict mathematical sense but instead means any profile which is substantially helical in nature and includes for example a twisted spiral strip where the edges of the spiral substantially form a generally helix profiled formation.

With reference to FIG. 1, the apparatus generally designated 10, comprises an inner bearing member 12 which is rotatably mounted within an outer bearing member 14 which in turn is fixed to an outer housing 16 such that the inner bearing member 12 may freely rotate relative to the outer housing 16. The outer housing 16 is secured to a base plate 18 in order to provide stability to the apparatus 10 and to allow the apparatus 10 to be temporarily or permanently secured to a work surface (not shown) if desired.

As best illustrated in FIG. 3, the inner bearing member 12 has a central aperture 19 therethrough and top and bottom transverse brush locating slots 20, 22 which each receive an upper and lower brush bar 24, 26 of an upper and lower scrubbing brush 28, 30 therein. Each of the scrubbing brushes 28, 30 are also provided with bristles 32, 34 projecting therefrom. In the presently described embodiment, the bristles 32, 34 comprise a wire metal material (such as e.g. steel or phosphor bronze); however, it will be appreciated by the skilled reader that these bristles may alternatively comprise any material such as nylon or PVC (or any other suitable durable material). Each of the scrubbing brushes 28, 30 are retained in their seated positions within the transverse brush locating channels 20, 22 by way of a brush locating plate 36 which is secured to the front face of the inner bearing member 12 during assembly of the apparatus 10.

The base plate 18 is provided with a pair of upright support posts 38 that receive the outer housing 16 therebetween and which are welded to the base plate 18 by welds 50. The outer housing 16 is retained in position within the upright support posts 38 by way of a front retaining plate 40 and a rear retaining plate 42 which are in turn held in position by angled flanges 44 of the support posts 38.

A frusto-conical guide collar 46 projects from the front of the retaining plate 40.

The rear retaining plate 42 has a helical member receiving tube 46 projecting rearwardly therefrom and a tapered suction flow directing nozzle 48 which connects the tube 46 to the rear plate 42. The tube 46 allows the apparatus 10 to be connected to a vacuum source inlet such as a suction tube of vacuum cleaner (not shown).

In use, when a user wishes to clean a helical member (such as a helical turbulator blade) he may first choose to connect the extension tube 46 to a vacuum cleaner or other suction device in order to establish a flow of air through the apparatus 10 and into the vacuum cleaner. Alternatively, the apparatus 10 may be used without any suction device.

The user next places one end of a helical member 52 into the open end of the guide collar 46 in order to locate that end of the helical member 52 between the distal ends of the scrubbing brush bristles 32, 34. Once in position between the ends of the scrubbing brush bristles 32, 34 the user then reciprocates the helical member 52 back and forth through the scrubbing brushes in the direction indicated by arrow A in FIG. 1. As the helical member 52 moves past the ends of the scrubbing brush bristles 32, 34 the helical profile of the helical member 52 imparts a rotational force on the inner bearing member 12 which hence rotates within the outer bearing member 14 in order to ensure that the ends of the scrubbing brush bristles 32, 34 each remain in good contact with the helical faces on either side of helical member 52. As the length of the helical member 52 is passed out through the rear plate 42 it will be received within the extension tube 46.

In this way, reciprocal movement of the helical member 52 through the scrubbing bristles 32, 34 of the apparatus 10 efficiently removes any carbon, soot, ash or other deposits on both sides of the helical member 52 with minimal expenditure of effort and time.

Furthermore, once any such deposits are scrubbed from the surfaces of the helical member 52 the flow of air established through the apparatus 10 by the attached vacuum source causes such deposits to be immediately carried away to the vacuum cleaner collection bag thereby preventing them from becoming airborne or otherwise clogging the components of the apparatus 10 itself.

A second aspect of the invention will now be described with reference to FIGS. 4 and 5 where, rather than rotating the brushes around the reciprocating, non-rotating helical member 52, the helical member 52 is itself rotated through stationary, non-rotating scrubbing brushes.

In this second aspect of the invention, a handle is provided for the user by way of a hand grip portion 110 which has a fixed outer bearing member 111 attached thereto. A corresponding rotating inner bearing member 113 is received within the outer bearing member 111 and is able to rotate freely with respect thereto. A collet member 115 is received within the end of the inner bearing member 113 and acts as a clamp to engage with a flattened end 51 of the helical member 52. A grub screw or other suitable arrangement is provided to clamp the flattened end 51 within the collet member 115 such that the helical member 52 may freely rotate with respect to the handle grip portion 110.

A corresponding scrubbing arrangement, generally designated 117, is also provided. The scrubbing arrangement 117 comprises an upper and lower brush bar 124, 126 which are each provided with scrubbing bristles 132, 134 projecting therefrom. Each of the scrubbing brushes are retained by upright posts 138 at either end thereof and a winged adjustment nut 119 is provided atop the scrubbing arrangement 117 in order to allow for the scrubbing friction force provided to the helical member 52 to be altered and adjusted as required. A base member 118 is also provided in order to provide stability to the scrubbing arrangement 117 and to allow the apparatus 10 to be temporarily or permanently secured to a work surface if desired.

In use, when a user wishes to clean debris from a helical member 52 making use of the apparatus of the second aspect, he first clamps the flattened end 51 of the helical member into the collet 115. This allows the user to securely hold the helical member 52 whilst allowing it to freely rotate along its longitudinal axis.

With the helical member 52 mounted on the handle 110, the user then progresses the opposite end of the helical member 52 between the ends of the scrubbing brush bristles 132 and 134. As the user progresses the helical member 52 through the ends of the scrubbing brush bristles 132, 134 the helical profile of the helical member 52 and its interaction with the bristles 132, 134 will cause the helical member 52 to rotate with respect to the handle 110. This therefore allows efficient and simultaneous cleaning of both sides of the helical member 52 as it is reciprocated back and forth through the ends of the scrubbing brush bristles 132, 134.

During use of the apparatus a vacuum cleaner suction tube (not shown) may be positioned in the vicinity of the scrubbing arrangement 117 in order to collect any deposits scrubbed from the surfaces of the helical member 52.

The above described aspects of the invention therefore provide a quick and efficient way of simultaneously cleaning both sides of a helical member and do not suffer from the disadvantages of known systems.

Although particular embodiments of the invention have been disclosed herein in detail, this has been done by way of example and for the purposes of illustration only. The aforementioned embodiments are not intended to be limiting with respect to the scope of the appended claims.

It is contemplated by the inventor that various substitutions, alterations, and modifications may be made to the invention without departing from the spirit and scope of the invention as defined by the claims. Examples of these include the following:

Different types and sizes of brushes, where the bristles comprise a different material and/or have a varying degree of coarseness or “gauge” may be provided as a kit of replacement brushes for different scrubbing functions. This allows the apparatus to be used to remove debris and contamination from e.g. helical turbulator members used in oil-burning, natural gas or LPG burning boilers.

Although use of the invention is described with reference to the cleaning of helical turbulator blades it may alternatively be used to clean, polish or otherwise engage with the surfaces of any substantially helical member.

1. Apparatus for cleaning a helical member, the apparatus comprising a first scrubbing member having a working surface adapted to remove deposits from a first helical face of a helical member passed thereover, the first scrubbing member being rotatably mounted on the apparatus such that, as the first helical face of the helical member is reciprocated over the first scrubbing member, the first helical face causes the first scrubbing member to rotate such that a working surface of the first scrubbing member remains substantially in contact with the first helical face to thereby remove deposits from the first helical face of the helical member.

2. Apparatus according to claim 1, further comprising a second scrubbing member adapted to remove deposits from a second helical face of the helical member passed between the first and second scrubbing members, the second scrubbing member being rotatably mounted on the apparatus such that, as the second helical face of the helical member is reciprocated over the second scrubbing member, the second helical face also causes the second scrubbing member to rotate such that a working surface of the second scrubbing member remains substantially in contact with the second helical face to thereby simultaneously remove deposits from the second helical face in addition to the first helical face of the helical member.

3. Apparatus according to claim 2, the first and second scrubbing members being mounted on a rotatable inner bearing member mounted within a fixed outer housing member.

4. Apparatus according to claim 3, the first and second scrubbing members being retained within the inner bearing member by a quick release retaining plate.

5. Apparatus according to claim 4, further comprising a front inlet plate and a rear outlet plate adapted to at least partially seal the interior of the apparatus.

6. Apparatus according to claim 5, the front inlet plate comprising a frusto-conical guide member adapted to guide entry of the helical member into the apparatus.

7. Apparatus according to claim 5, the rear outlet plate being adapted to allow connection to a vacuum source in order to collect any deposits scrubbed from helical member.

8. Apparatus according to claim 7, further comprising a tubular extension member adapted to receive the length of the helical member therewithin during reciprocal movement of the helical member through the apparatus.

9. Apparatus according to claim 3, wherein the or each scrubbing member comprises a scrubbing brush.

10. Apparatus according to claim 1, the helical member comprising a turbulator blade.

11. A method of cleaning a helical member, the method comprising a steps of reciprocating a helical member through an apparatus comprising a first scrubbing member having a working surface adapted to remove deposits from a first helical face of a helical member passed thereover, the first scrubbing member being rotatably mounted on the apparatus such that, as the first helical face of the helical member is reciprocated over the first scrubbing member, the first helical face causes the first scrubbing member to rotate such that a working surface of the first scrubbing member remains substantially in contact with the first helical face to thereby remove deposits from the first helical face of the helical member.

12. A method according to claim 11, further comprising attaching a vacuum source to the apparatus in order to capture and collect any debris scrubbed from the helical member during use of the apparatus.

13. Apparatus for cleaning a helical member, the apparatus comprising:
a first helical member retaining arrangement adapted to hold an end portion of a helical member, and
a handle member,
the retaining arrangement being rotatably mounted relative to the handle member such that, when a user reciprocates the helical member past a scrubbing arrangement to remove debris from the helical member, the helical member is able to rotate relative to the handle member.

14. Apparatus according to claim 13, the retaining arrangement comprising a clamping member for clamping a flattened end of the helical member therein.

15. Apparatus according to claim 13, the retaining arrangement being mounted on a bearing within the handle member.

16. A method of cleaning a helical member comprising the steps of securing an end of a helical member to an apparatus comprising a first helical member retaining arrangement adapted to hold an end portion of a helical member and a handle member, the retaining arrangement being rotatably mounted relative to the handle member such that, when a user reciprocates the helical member past a scrubbing arrangement to remove debris from the helical member, the helical member is able to rotate relative to the handle member, and reciprocating the helical member through or over a scrubbing arrangement in order to remove deposits from the helical member.

17. A kit of parts for cleaning a helical member, the kit of parts comprising;
a handle member;
a first helical member retaining arrangement adapted to hold an end portion of the helical member, the retaining arrangement being rotatable relative to the handle member; and
a scrubbing arrangement comprising:
a fixed first scrubbing member having a working surface adapted to remove deposits from a first helical face of the helical member passed thereover such that, as the first helical face of the helical member is reciprocated over the first scrubbing member, the first helical face causes the helical member to rotate relative to the handle member such that a working surface of the first scrubbing member remains substantially in contact with the first helical face to thereby remove deposits from the first helical face of the helical member: and
a second scrubbing member adapted to remove deposits from a second helical face of the helical member passed between the first and second scrubbing members such that, as the second helical face of the helical member is reciprocated over the second scrubbing member, the second helical face also causes the helical member to rotate such that a working surface of the second scrubbing member remains substantially in contact with the second helical face to thereby simultaneously remove deposits from the second helical face in addition to the first helical face of the helical member.

18. (canceled)

19. (canceled)
